(19) United States
(12) Patent Application Publication
(10) Pub. No.: US 2026/0187425 A1
(43) Pub. Date: Jul. 2, 2026

(54) WEIGHTED PATH SEARCH ACCELERATED BY SPIKING NEUROMORPHIC HARDWARE

(71) Applicant: Intel Corporation, Santa Clara, CA (US)

(72) Inventors: Philipp Stratmann, Bonn (DE); Ashish Rao Mangalore, Munich (DE)

(73) Assignee: Intel Corporation, Santa Clara, CA (US)

(21) Appl. No.: 19/548,192

(22) Filed: Feb. 24, 2026

Related U.S. Application Data
(60) Provisional application No. 63/763,401, filed on Feb. 26, 2025.

(51) Int. Cl. G06N 3/049; G06N 3/042

(52) U.S. Cl. CPC G06N 3/049; G06N 3/042

(57) ABSTRACT

Nodes in a graph may be encoded in neurons of a neural network. Forward and backward spiking phases may be conducted to find shortest path. During the forward spiking phase, each neuron may update its state after determining that a spike it has received from a spiking neuron in the last time step has a value smaller than its current state value. The spike may include an edge weight and a state of the spiking neuron. During the backward spiking phase, each neuron may update its other state based on a spike from a neighboring neuron in a time step and an index of the current time step. The neuron may send its identifier (ID) to a host based on its states. The host may identify the shortest path from the source node to the target node based on neuron IDs it receives.

### CROSS-REFERENCE TO RELATED APPLICATION

This application claims the benefit of U.S. Provisional Ser. No. 63/763,401 , filed Feb. 26, 2025, and titled “WEIGHTED PATH SEARCH ACCELERATED BY PARALLEL, ASYNCHRONOUS, COMPUTE-MEMORY INTEGRATED PROCESSORs,” which is incorporated herein by reference in its entirety for all purposes.

### TECHNICAL FIELD

This disclosure relates generally to graph search, and more specifically, weighted path search accelerated by spiking neuromorphic hardware, such as parallel, asynchronous, compute-memory integrated processors with spiking neuromorphic architectures.

### BACKGROUND

A graph is a data structure comprising a collection of nodes (or vertices) and one or more edges. An edge is a connection of two nodes. Graphs are used in a wide variety of applications, including robotics, database queries, financial transactions, vehicle routing, logistics, social network analysis, and so on. In many applications, a graph problem is the shortest path problem, which is the problem of finding a path between two nodes in a graph such that the number of edges (or the sum of the weights of the edges) between the two nodes is minimized. Such a path may be considered as the shorted path in the graph.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a graph search system, in accordance with various embodiments.

FIGS. 2A and 2B illustrate example graphs, in accordance with various embodiments.

FIGS. 3A-3C illustrate spike propagation in a spiking neural network during a forward spiking phase, in accordance with various embodiments.

FIGS. 4A-4C illustrate spike propagation in the spiking neural network during a backward spiking phase, in accordance with various embodiments.

FIG. 5 illustrates an example spiking neuromorphic processor, in accordance with various embodiments.

FIG. 6 illustrates an example process of planning motion of a robot, in accordance with various embodiments.

FIG. 7 is a flowchart showing a method of graph path search, in accordance with various embodiments.

FIG. 8 is a block diagram of an example computing device, in accordance with various embodiments.

### DETAILED DESCRIPTION

Graph problems are ubiquitous to many applications in robotics, database queries, financial transactions, vehicle routing, logistics, and so on. Traditionally, finding the shortest path in a graph problem involves application of shortest-path algorithms on conventional computer architectures, The shortest path problem is usually solved on traditional architectures like central processing units (CPUs) and graphics processing units (GPUs) using algorithms like Dijkstra's search or variants of A* search. Dijkstra's algorithm can be the optimal graph search algorithm for sequential processing of graphs with purely positive weights. A* search is an extension of Dijkstra that typically uses heuristics for acceleration. The Bellman-Ford algorithm, which is in general slower than Dijkstra's algorithm on sequential hardware like CPUs, typically allows acceleration on parallelly computing hardware and can handle graphs with negative weights.

Solving this problem on CPUs typically involves serially exploring possible paths in the graph, which can lead to slow performance. The problem is NP-hard by definition and therefore possible speed-up avenues are based on heuristics or parallelization. Parallel search strategies on GPUs are typically limited in exploiting the parallelism inherent to the graphs. Due to the small core count compared to graph size, GPUs perform the search in batches, and because GPUs do not integrate compute and memory, batching results in costly data transfer. In applications like robotics, where a robot typically needs to react in real time, solving graph problems on traditional computer architectures can be prohibitively slow or require the use of very compute-heavy, energy-intensive computers which makes their use in mobile robots infeasible. This results in the usage of Application Specific Integrated Circuits (ASICs) to solve these kinds of problems. However, the use of ASIC based solutions restricts the application of the solution to a particular variant of the problem and does not offer generalizability. They can consume orders of magnitude higher energy than conventional solutions to solve this problem thus limiting their application in problems with hundreds of millions of graph vertices.

Embodiments of the present disclosure may improve on at least some of the challenges and issues described above by a method to accelerate shortest-path graph search and solution readout for weighted graphs, with positive or negative weights, on spiking neuromorphic hardware. In an example, spiking neuromorphic hardware may be a processing unit (“processor”) with a spiking neuromorphic architecture. A spiking neuromorphic processor may have integrated compute and memory features. Spiking neuromorphic architectures with integrated compute and memory features may have smaller cores than CPUs or GPUs and can form systems including millions of cores, which allows to encode graphs orders of magnitude larger than currently solvable. This disclosure provides a method to perform an efficient search and readout for weighted graphs, with positive and negative weights, on neuromorphic hardware. It can facilitate solving a substantially larger set of commercially relevant graph problems, such as finding the shortest path in street maps.

In various embodiments of the present disclosure, a graph includes nodes connected with one or more edges. An edge may be weighted, meaning the edge may have a weight, which may be positive or negative. Each node in the graph may be encoded in a neuron of a neural network. The neural network may be implemented on a spiking neuromorphic processor. The neural network may be a hardware neuron network where hardware neurons are communicatively connected through interconnects. An interconnect can relay messages in the form of spikes. Interconnects allow neurons to be connected to each other, e.g., by routing tables. Such a connection between two or more neurons is a synapse. Each edge in the graph may be encoded in one or more synapses of the neural network. To find the shortest path between a source node and a target node in the graph, forward and backward spiking phases may be conducted using the processor. In the forward spiking phase, spikes propagate forwards within the neural network, i.e., in a direction from the source node to the target node. In the backward spiking phase, spikes propagate backwards within the neural network, i.e., in a direction from the target node to the source node. The state of the source neuron may be set to 0 and the state of the other neurons may be set to infinity.

During the forward spiking phase, a set of neuron states may be updated. A neuron state may be a value indicating a distance between the corresponding node and the target node in the graph. The neuron state may be a memory flag stored in a memory of the neuron and may be updated by updating the memory flag. Each neuron may determine whether a spiking message (“spike”) it has received in the last time step has a value smaller than its current state value. In response to determining that the value in the spiking message is smaller, the neuron may update its state value to the value in the spiking message. Otherwise, the neuron may keep its state value as is. The neuron may send a spike having its updated state value to its neighboring neuron(s). A spike may include multiple messages sent through multiple synapses. When a neuron receives multiple spikes from multiple neighboring neurons, the neuron may compute a value based on each spike and update its state to the smallest value. A sequence of time steps may be performed during the forward spiking phase till a spike reaches the target neuron. The target neuron may update its state based on the spike. The update state of the target neuron may indicate a distance between the target node and source node in the graph.

The backward spiking phase includes a sequence of time steps. Each time step may have a positional index indicating the position of the time step in the sequence. For instance, the positional index of the first time step may be 1, and the positional index of the second time step may be 2. During the backward spiking phase, another set of neuron states may be updated. A neuron state in this set may be a value indicating a distance between the corresponding node and the source node in the graph. The neuron state may be a memory flag stored in a memory of the neuron and may be updated by updating the memory flag. The state of the target neuron for the backward spiking phase may be set to 0, and the target neuron may send out a spike comprising the state value 0. A neuron neighboring the target neuron may update its state based on the spike from the target neuron and the positional index of the current time step. When the positional index is smaller, the neuron updates its state value to the positional index. Otherwise, the neuro may keep its state value as it. The neuron may also compute a sum of its two states and determine whether the sum equals the distance between the target node and source node in the graph. When the sum equals the distance, the neuron may send its identifier (ID) to a host. The host may identify the shortest path from the source node to the target node based on neuron IDs it receives. The neurons that send IDs to the host may be neurons on the shortest path.

This disclosure provides a method to solve graph search quickly and energy efficiently by finding the shortest path and streaming out the sequence of vertices that constitute the shortest path. The method may use hardware that is programmable, compute-memory integrated, sparsely communicating, or fine-grained parallel. This hardware can scale especially well for large graphs, such as graphs with millions/hundreds of millions of graph vertices. The method in this disclosure can not only focus on fast and energy-efficient computation of the shortest possible path but also allow finding it on dynamically changing graphs, constrained graphs or graphs with constraints on the weights/vertices of the shortest path.

Solving graph search and solution readout with the method using spiking neuromorphic hardware has benefits in various metrics, including time-to-solution, energy, scale, and versatility. The distributed cores in the hardware in this disclosure can lead to fine-grained parallelism which means the parallelism of the system can adapt to the parallelism of the problem on the fly. This can ensure that the solution can be found as quickly as possible. Moreover, the usage of CPU cores coupled with the distributed neuromorphic cores can ensure that the readout of the sequence of vertices that constitute the solution is as fast as possible. Also, the distributed cores in the hardware in this disclosure can sparsely operate and communicate on a need-to-use basis, that is, they function asynchronously. As a result of this, the energy consumption to solve graph search and solution readout can fall drastically.

The nature of the graph search and solution readout problem makes it hard to solve them in time budgets required for real-time applications, e.g., robotics and self-driving cars. The fine-grained parallelism inherent to spiking neuromorphic hardware can make it an ideal candidate to solve graph search and solution readout in real time for these applications. The complexity of the neuromorphic solution can scale with the actual length of the shortest path. A sequential algorithm on CPUs scales with the number of edges. Moreover, clock-based ASICs, that are hard-coded to solve instances of path search problems end up solving the problems with a few tens of thousands of graph vertices at 2-3 order of magnitude higher energy levels than possible with spiking neuromorphic hardware. This makes it untenable for use in mobile applications or applications that are limited by battery capacity. Further, the programmability of the hardware used in this disclosure allows it to be used for graphs that change dynamically, graphs that are constrained or graphs that co-depend on other processes. In other words, the approach in this disclosure can be versatile to different types of graphs.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phase “A or B” means (A), (B), or (A and B). For the purposes of the present disclosure, the phrase “A, B, and/or C” or the phase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

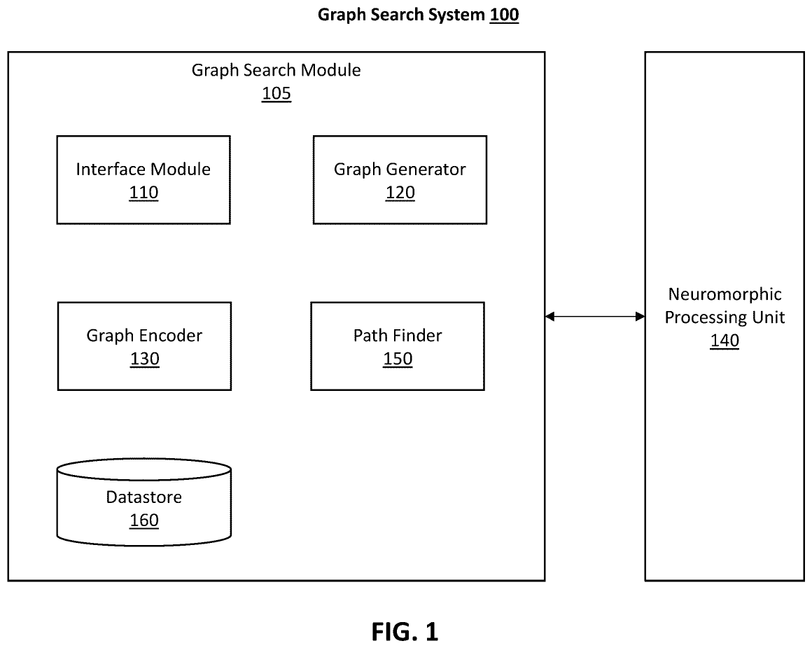

FIG. 1 is a block diagram of a graph search system 100, in accordance with various embodiments. The graph search system 100 includes a graph search module 105 and a neuromorphic processing unit 140. The graph search module 105 includes an interface module 110, a graph generator 120, a graph encoder 130, a path finder 150, and a datastore 160. In other embodiments, alternative configurations, different or additional components may be included in the graph search system 100. Further, functionality attributed to a component of the graph search system 100 may be accomplished by a different component included in the graph search system 100 or by a different system.

The graph search system 100 may be implemented in software, hardware, firmware, or some combination thereof. In some embodiments, the neuromorphic processing unit 140 may be a processing unit that can execute neural networks with spiking neuromorphic architectures. The neuromorphic processing unit 140 may be at least part of a spiking neuromorphic processor. The graph search module 105 may at least partially run on a host device. The host device may include one or more CPUs. In some embodiments, the host device and the neuromorphic processing unit 140 may be on the same chip. In other embodiments, the host device and the neuromorphic processing unit 140 may be on separate chips.

The interface module 110 facilitates communications of the graph search system 100 with one or more other systems. For example, the interface module 110 may receive data from one or more systems or devices, the operation of which may produce data that can be used to solve graph problems. The data may be used by the graph generator 120 to define a graph problem, generate a graph, etc. As another example, the interface module 110 may transmit data computed by the graph search system 100 to one or more systems or devices that may operate based on solutions found by the graph search system 100. Examples of systems or devices that send data to or receive data from the interface module 110 may include robots, navigation systems, e-marketing systems, control systems, mapping systems, depth measurement systems, and so on.

The graph generator 120 generates graphs. The graphs can be used for various applications, such as robotics, database queries, financial transactions, vehicle routing, logistics, social network analysis, and so on. A graph may be a data structure that includes nodes and edges. A node is an entity in the graph. A node may represent an object (person, animal, building, tree, vehicle, etc.), measurement (e.g., dimension, weight, pressure, volume, etc.), signal (e.g., text, image, video, audio, etc.), location, user account, and so on. An edge is a connection of two nodes. An edge may represent a relationship between the two nodes, such as affinity, connection, proximity, and so on. A node may be connected to multiple other nodes through multiple edges. A graph may be associated with one or more embeddings. For instance, the graph may have a graph embedding that encodes one or more characteristics of the graph, a node in the graph may have a node embedding that encodes one or more characteristics of the node, or an edge in the graph may have an edge embedding that encodes one or more characteristics of the edge. An embedding may be a vector, which is also referred to as embedding vector.

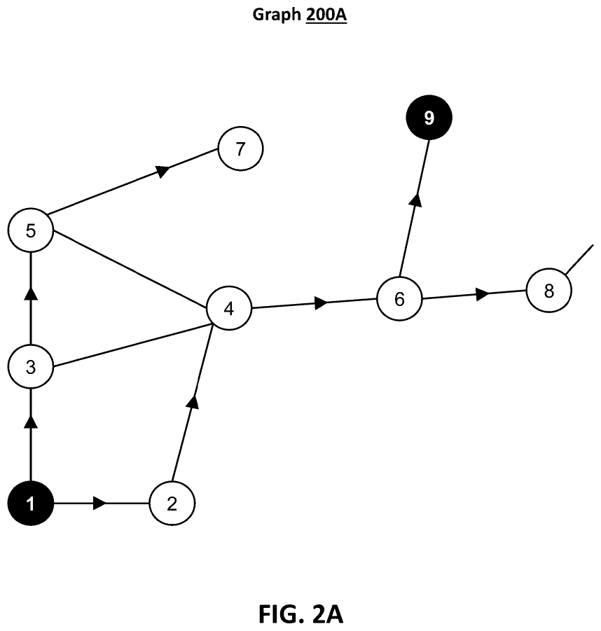

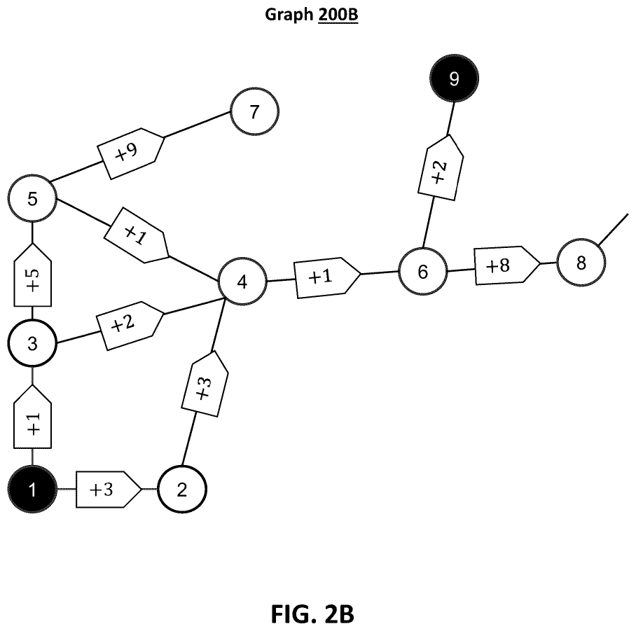

In some embodiments, the graph generator 120 may generate graphs based on data from a system or device associated with the graph search system 100. For example, the graph generator 120 may receive a request from a control system of a robot to plan a motion of the robot. The graph generator 120 may also receive information about the environment where the robot moves. The information about the environment may include sensor data captured by the robot. The graph generator 120 may generate a graph based on the request and the information of the environment. In other examples, the graph generator 120 may generate graphs to be used for other purposes. Certain aspects of graphs generated by the graph generator 120 are provided below in conjunction with FIGS. 2A and 2B.

The graph encoder 130 encodes graphs to spiking neural networks. A spiking neural network may be a neural network with a spiking neuromorphic architecture. The graph encoder 130 may receive a graph from the graph generator 120. The graph encoder 130 may encode the graph to a spiking neural network comprising a plurality of neurons that are in communication. In some embodiments, the graph encoder 130 may map nodes of the graph to neurons of the spiking neural network. Different nodes may be encoded to different neurons. The graph encoder 130 may map each edge of the graph to communicative connection(s) between the corresponding neurons. In some embodiments (e.g., embodiments where an edge has weights), the graph encoder 139 may introduce a delay proportional to the weight to the communicative connection between the corresponding neurons, which may delay the communication (e.g., transmission of spiking message) between the neurons.

A spike of information may propagate through the neurons in the spiking neural network through the communitive communications. The information in the spike may include a variable defining a state of the spiking neuron, which may indicate an attribute of the node encoded by the neuron. In some embodiments, the variable may be a depth value that indicates the depth of the node on a path in the graph. The path may be between two nodes of the graph, e.g., a path from a start node to a target node. The graph may have multiple paths between the start node and the target node. The variable defining the state of a neuron may be stored in a memory associated with the neuron as a memory flag. The graph encoder 130 may also determine one or more criteria for the neurons to spike. A neuron may spike after it meets a criterion. The spiking neuron can transmit the spike of information to one or more other neurons that are in communitive connection with the spiking neuron. The spike may carry the memory flag of the spiking neuron. The graph encoder 130 may also instruct a neuron, which has received the spike, to determine whether to update its internal value based on the value in the spike.

The graph encoder 130 may manage spike propagations in the spiking neural network. For instance, the graph encoder 130 may select a neuron where a spike propagation starts. The neuron may be the start neuron of the spike propagation. The start neuron may encode a start node of a path in the graph, e.g., in embodiments where the spike propagation is a forward spike propagation, or a target node of a path in the graph, e.g., in embodiments where the spike propagation is a backward spike propagation. Additionally or alternatively, the graph encoder 130 may select a neuron where the spike propagation ends. The neuron may be the target neuron of the spike propagation. The target neuron may encode a target node of a path in the graph, e.g., in embodiments where the spike propagation is a forward spike propagation, or a start node of a path in the graph, e.g., in embodiments where the spike propagation is a backward spike propagation. In an embodiment, the graph encoder 130 may set the initial internal state of neurons.

In some embodiments, the graph encoder 130 may obtain identifying information of the neurons encoding in the neural network. The identifying information of a neuron may include a serial number, identifier (ID) number, location information, or other information that can identify the neuron in the neural network. Additionally or alternatively, the identifying information of a neuron may include information indicating which node in the graph is encoded by the neuron. For instance, the identifying information may include a serial number, ID number, position in the graph, information about connection with other neurons, or other information that can identify the node. The graph encoder 130 may provide the identifying information of the neurons to the path finder 150 for finding the shortest path in the graph. The graph encoder 130 may also instruct neurons to provide their identifying information to the path finder 150 after one or more criteria is met. An example criterion may be the depth value of the neuron for a spike probation from a first neuron to a second neuron being equal to the depth value of the neuron for a spike probation from the second neuron to the first neuron.

The neuromorphic processing unit 140 implements neural networks with spiking neuromorphic architectures, such as spiking neural networks that encode graphs. In some embodiments, the neuromorphic processing unit 140 may implement a single neural network at a time. In other embodiments, the neuromorphic processing unit 140 may implement multiple neural networks simultaneously. In some embodiments, the neuromorphic processing unit 140 may include distributed computing units called “neurons” and an interconnect that can relay messages in the form of spikes. The interconnect allows neurons to be connected to each other, e.g., by routing tables, each such connection is called a “synapse”. The persistent and temporal variables defining the state of each neuron can be updated based on input spikes from other neurons, the specific updating rules can be programmed via microcode. The benefit of having an event-based paradigm is that information is communicated on a need-to-use basis thus reducing compute and, as a consequence, energy consumption.

In some embodiments, the neuromorphic processing unit 140 may include one or more compute blocks. Each compute block may include a plurality of compute elements (“processing elements”). A processing element can perform computations, such as accumulation, subtraction, multiplication, division, other types of computations, or some combination thereof. In some embodiments, a processing element may be a neuron. In other embodiments, multiple processing elements may constitute a neuron. A processing element may be communicatively connected to one or more other processing elements, which may be in the same compute block as the processing element or in a different compute block. In some embodiments, the communicative connection between two processing elements may be facilitated by an in-memory compute element, which may be a synapse. Processing elements in communicative connection may send data to each other, e.g., when the processing elements spike. The communication between two processing elements may be bidirectional so that they can pass spikes to each other in both forward spike propagation and backward spike propagation.

In some embodiments, the neuromorphic processing unit 140 may include one or more memories, which may be implemented on the same chip as the processing elements. In an example, a compute block may have its own memory that is shared by the processing elements in the compute block. The memory may store data computed by the processing elements. In some embodiments, operations of the neuromorphic processing unit 140 may be managed by the graph encoder 130.

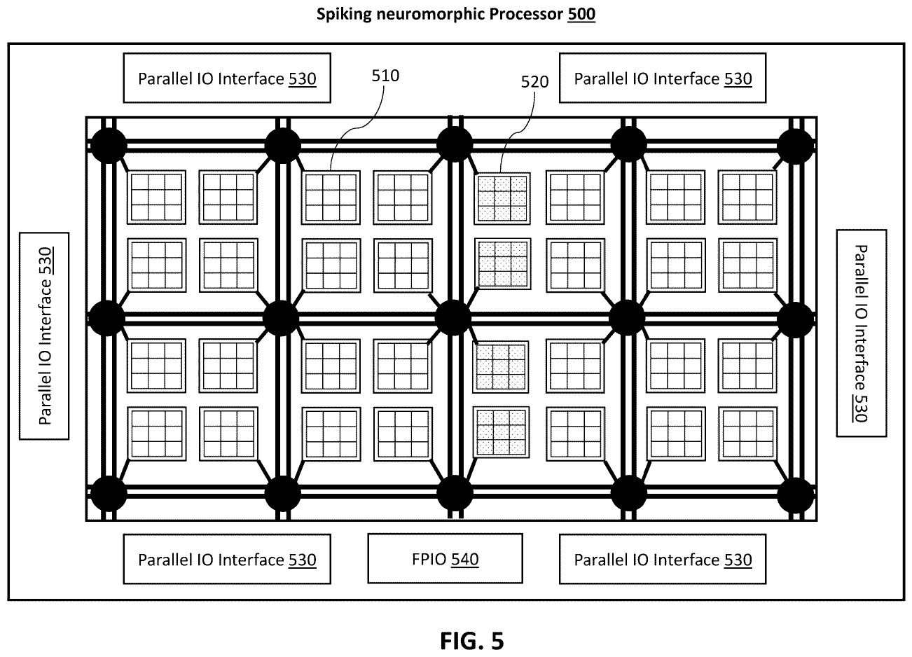

The neuromorphic processing unit 140 may be programable, which can allow the usage of different types of update equations in a neuron in the neural network, thereby enabling the graph search system 100 to solve various graph search problems. In some embodiments, auxiliary operations can be integrated with graph search problem or performed along with graph search. The compute-memory architecture of the neuromorphic processing unit 140 can reduce or minimize data transfer between compute and memory elements across compute cycles. Certain aspects of the neuromorphic processing unit 140 are described below in conjunction with FIG. 5.

The path finder 150 finds the shortest paths in graphs. The path finder 150 may receive information about a graph from the graph generator 120, such as the nodes in the graph, edges in the graph, and so on. In some embodiments, the path finder 150 may also receive, e.g., from the graph generator 120, information indicating a start node and a target node, between which the shortest path needs to be found. The path finder 150 may also receive information about the spiking neural network that encodes the graph from the graph encoder 130, such as identifying information of the neurons in the neural network, communitive connections between the neurons, and so on. The path finder 150 may receive identifying information of neurons (e.g., a subset of the neurons in the neural network) from the neuromorphic processing unit 140 executing the neural network.

The path finder 150 may identify one or more nodes in the graph based on information received from the graph generator 120, the graph encoder 130, the neuromorphic processing unit 140, or some combination thereof. For instance, the path finder 150 may identify the start node and end node. In some embodiments, the path finder 150 may determine other nodes in the graph. The shortest path may include the start node, the identified node(s), the target node, and the edges between these nodes. The shortest path may be a solution to a graph problem based on which the graph generator 120 generates the graph. In some embodiments, the path finder 150 may provide the shortest path to a system or device associated with the graph search system, where the shortest path may be used for various applications.

The path finder 150 may determine the shortest path from the start node to the target node using a spiking neural network that encodes the graph. The spiking neural network may be implemented on the neuromorphic processing unit 140. In some embodiments, each neuron nᵢ of the spiking neural network represents a vertex vi in the graph, where i denotes the index of the neuron or vertex. The neurons in the spiking neural network may be connected to each other using in-memory compute elements (“synapses”), where each synapse between two vertices represents the edge between two vertices. In an example where vᵢ and vⱼ are connected by a mono-directional edge e_{i,j}, the corresponding neurons nᵢ and nⱼ are connected by a synapse that allows messages from i to j. When the edge is bidirectional, the neurons i, j may be connected by two synapses, one forwarding messages from i to j and one forwarding messages from j to i. Each neuron nᵢ may have an internal state dᵢ (ho p_{fwd}) in memory that denotes its shortest distance from the source vertex. This state may be initiated, e.g., by the graph encoder 130, for all neurons as infinite (∞) or as a flag that denotes that the vertex does not have a value for its shortest distance to the source vertex, yet. In some embodiments, the weight w_{i,j} of the edge e_{i,j} may be stored in the synapse between the neurons. Another synapse between these two neurons may exist of weight+1. Both synapses may converge to a dendritic accumulator (DA) at neuron j, DA_{j,j}. For each connection between two nodes, there may be a separate DA. In other embodiments, the two neurons may be connected by a synapse with a multiplicative weight+1 and an additive bias term w_{i,j}.

Short path search can be enabled by the underlying operating in two phases, a forward spiking phase and a backward spiking phase. The forward phase is involved in computing the shortest path lengths and the backward spiking phase is for reading out on the shortest path(s) in sequence. The forward spike propagation may start with sending a message indicating payload 0 to an input DA of the source neuron. The message can signal the neuron that it has a distance 0 from the source neuron, trivially implying that it is the source neuron.

The forward spiking phase may include a sequence of iterations. An iteration may also be referred to as a time step. Each iteration may include a plurality of processing steps. The processing steps may be performed iteratively through the timesteps. The total number of iterations in the forward spiking phase may be a predetermined parameter, which may be referred to as a timeout parameter. In some embodiments, the timeout parameter is set to |V|−1, where |V| denotes the number of nodes.

In the first processing step of each iteration, each neuron nᵢ may determine whether the value in its incoming message from the last iteration is smaller than their current value dᵢ. In the second processing step, when the new smallest value is not smaller than the previous dᵢ, the neuron may do nothing. Most neurons may not perform any memory updates or send any messages in each step, leveraging the asynchronous nature of neuromorphic hardware. When the new value is smaller than dᵢ, the neuron can update dᵢ to the new, smaller value. It may also send messages to each neighboring neuron j (for all existing edges e_{i,j}) via the corresponding synapses. The goal is to notify the neuron j that, when its shortest path is to go via neuron i, its distance is dᵢ+w_{i,j}. To convey this information, the neuron i may send two messages. The first message may indicate payload +1 and may be sent via a synapse of weight w_{jd i,j}, thus, a payload of (1·w_{i,j}) may arrive at neuron nⱼ. The second message may carry a payload dᵢ via a synapse of weight +1, resulting in a payload of (1·dᵢ) may arrive at the postsynaptic neuron nⱼ. The two messages may be a single spike or two spikes. A synapse may be a communication link between the two neurons. Both synapses may converge on the compute element D A_{j,j}, which can provide hardware acceleration to add all incoming elements up, producing the incoming message dᵢ+w_{i,j}. Each neuron j has an individual DA for each edge e_{i,j}. In some embodiments, hardware may have synapses that provide an additive bias term, allowing to perform the calculation payloadᵢ+w_{i,j}. In this case, the neuron nᵢ only needs to send a single message via this single synapse, with payloadᵢ=dᵢ. At neuron nⱼ, all synapses from all neighboring neurons converge onto a single Dendritic Minimizer (DM). This compute element calculates the minimum of all incoming messages.

In the third processing step, all neurons j may

receive their messages and choose the message with the smallest value \hat{d}ⱼ. This number may indicate a new guess for the minimum distance of j from the source neuron. The neuron determines this value \hat{d}ⱼ. In some embodiments, the neuron j may feature a single DA for each neuron i that connects to it, i.e. where eᵢⱼ exists. Out of all messages received by the individual DAs, the programmable neuron j may choose the smallest of these values as \hat{d}ⱼ. In other embodiments, all messages may converge on a hardware-accelerated DM. This DM may receive messages from all neurons i. Unlike DA, the DM may not add up all incoming messages but provide a hardware-accelerated minimization operation by calculating the smallest value of all incoming messages.

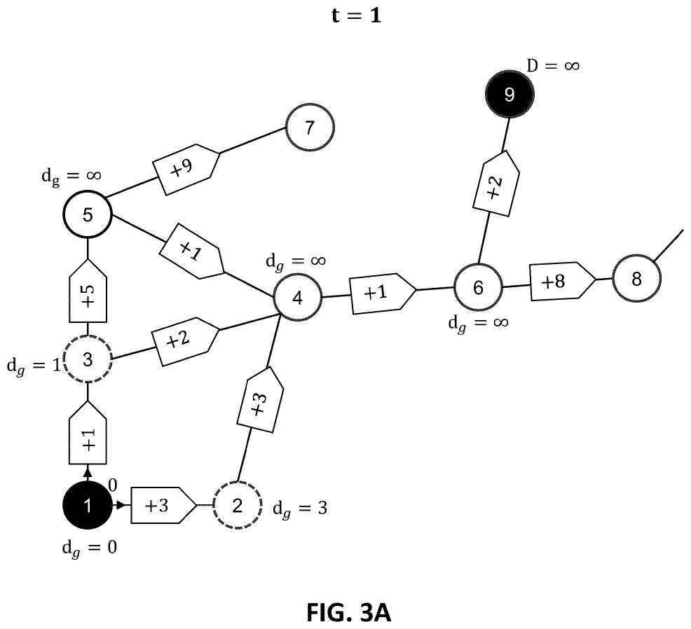

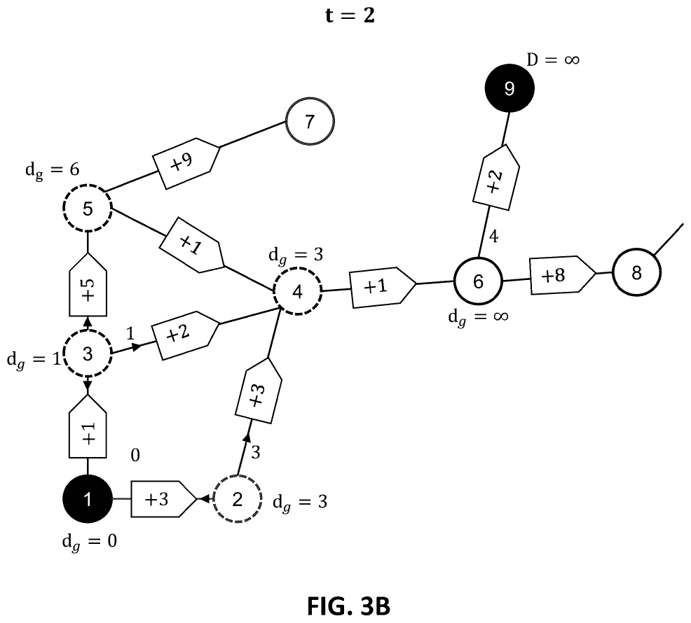

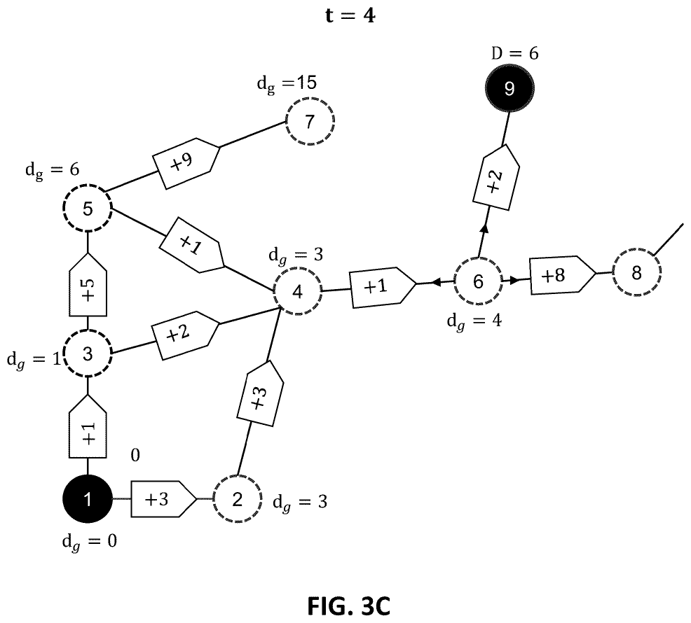

In some embodiments, the three processing steps of an iteration can be parallelized. For instance, multiple compute cores of the neuromorphic processing unit 140 can update multiple neurons in parallel. In some embodiments, all neurons can be updated in parallel, requiring as many parallel compute threads as there are neurons. Certain aspects of forward spiking phase are described below in conjunction with FIGS. 3A-3C.

The backward spiking phase may start after the forward spiking phase completes. The backward spiking phase may involve a backward wave that calculates the distance of the neurons from the target node, which is denoted as bᵢ(ho p_{bwd}). The distance calculation and its accompanying spiking mechanism may be similar to the forward wave. In some embodiments, the spikes during the backward spiking phase are forwarded by neurons on the shortest path. The other neurons may not forward spikes. The values of dᵢ and bᵢ at a node i may be added and compared to the depth at the target neuron, dₜ, which was computed and transmitted after the end of the forward wave. When dᵢ+bᵢ=dₜ, the neuron may determine that it is on a shortest path and may continue the backward spike wave by sending a message with payload dⱼ to all neurons that it is connected to with a backwards synapse, thereby ending the iteration or time step. It may also send its ID to the host CPU. This procedure may be repeated until the first spike arrives back at the source neuron. Like the forward spike wave, also the backwards spike wave can be processed by distributing all neurons onto separate threads/processing cores to parallelize their processing.

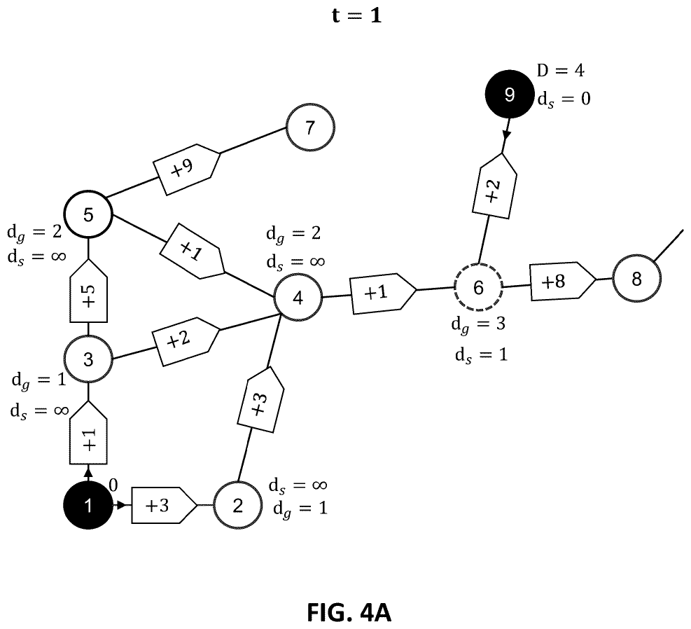

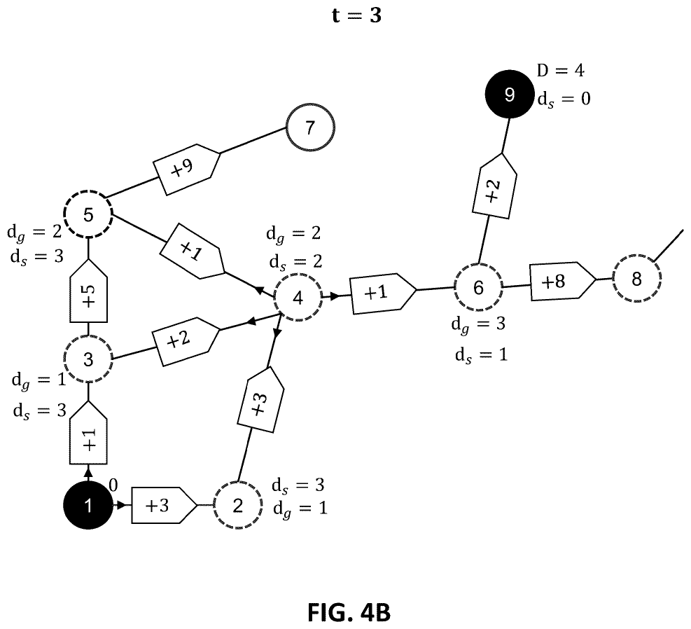

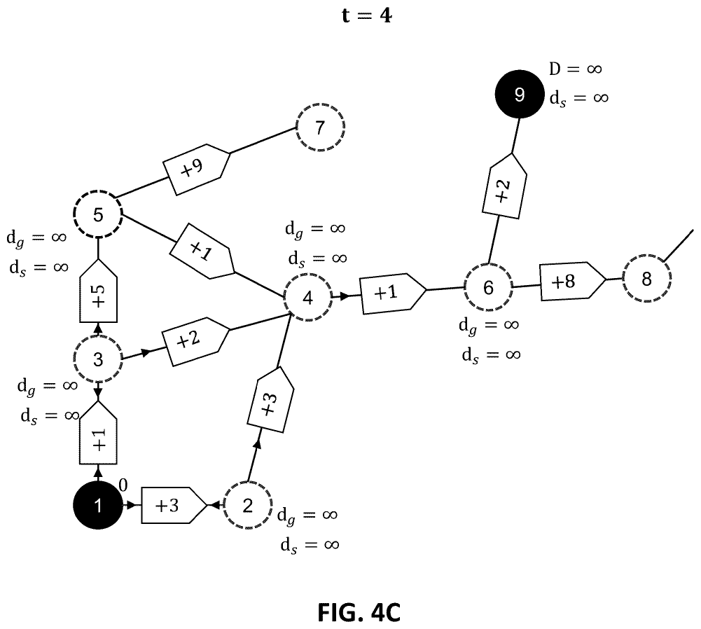

In some embodiments, the backward spiking phase may be initiated once the target neuron has received its first spike, upon which a readout can be triggered. At this point, the neurons start operating in backward mode. The target neuron initiates a spike wave that travels along the same connectivity in the opposite direction. The neurons use state variables (e.g., ho p_{bwd}, D, ho p_{fwd}) to check whether a neuron that has received a spike is a solution for the shortest path. This may be initiated by the target neuron sending its ho p_{bwd} as value of the spike. When a neuron receives a backward spike, it may assign the value of ho p_{bwd} as the sum of the edge weight and the incoming spike (ho p_{bwd} of successor neuron in shortest path). This value may be added to the ho p_{fwd} variable to check whether the sum is equal to the global depth. When the node is ascertained to be part of the solution, it is read out. Certain aspects of backward spiking phase are described below in conjunction with FIGS. 4A-4C.

A single shortest path can be found through the forward phase and backward spiking phase. In some embodiments, there can be multiple shortest paths of same distance. To guarantee the identification of all shortest paths, the spiking neural network may be run for longer. For instance, the spiking neural network may be run for a total of |V| time steps. In some embodiments, all neurons may be connected to a supervisory neuron or embedded CPU. They may signal a message of +1 to this supervisor whenever they have updated their distance dᵢ. When the supervisor does not receive a single message in a time step, it can stop the execution since no shorter messages can be retrieved.

The datastore 160 stores data received, generated, used, or otherwise associated with the graph search system 100. For example, the datastore 160 stores graphs generated by the graph generator 120, data used by the graph generator 120 to generate graphs, data provided to or generated by the neuromorphic processing unit 140, information of paths found by the path finder 150, and so on. In the embodiment of FIG. 1, the datastore 160 is a component of the graph search system 100. In other embodiments, the datastore 160 may be external to the graph search system 100 and communicate with the graph search system 100 through a network. In some embodiments, part of the datastore 160 may be implemented in the neuromorphic processing unit 140. For instance, the neuromorphic processing unit 140 may include one or more memories that store data provided to or generated by the compute element in the neuromorphic processing unit 140.

FIGS. 2A and 2B illustrate example graphs 200A and 200B, in accordance with various embodiments, in accordance with various embodiments. A graph may be a data structure including a collection of nodes (aka “vertices”). The nodes are linked through connections. A connection is referred to as an edge. A graph may be denoted as G=(V, E), where V refers to the nodes and E refers to the edges. An edge may connect two node in the graph. For illustration, the graph 200A in FIG. 2A and the graph 200B in FIG. 2B each have 9 nodes and 10 edges. The 9 nodes are represented by circles labeled with 1 through 9. The nodes are referred to as Node 1 through Node 9, respectively. In other embodiments, the graph 200A or graph 200B may include a different number of nodes or different edges.

The graph 200A or graph 200B may be used to represent various types of data, such as text, image, data about a social network, and so on. In an example where the graph 200A or graph 200B represents an image, a node may represent a feature in the image. The edges may indicate relationships between the features in the image. A node may be associated with an embedding that encodes information about the feature, such as color, shape, size, classification, and so on. In another example, the graph 200A or graph 200B may represent an area, e.g., an area surrounding a robot. A node may represent a spot or object in the area. An edge may indicate a traveling path in the area. In another example, the graph 200A or graph 200B may represent a social network. A node may represent a person using the social network. The edges may indicate affinity among the people in the social network. In other examples, the graph 200A or graph 200B may represent other data.

The graphs 200A and 200B may be used to solve problems in various applications, including robotics, database queries, financial transactions, vehicle routing, logistics, and so on. A graph problem may involve finding the shortest path within the graph. Shortest path and solution readout may refer to the process of finding the sequence of nodes that constitute the shortest path between two nodes in the graph. In some embodiments, the shortest path may be unidirectional and may be from a source node (“start node”) to a target node (“goal node” or “end node”). In the examples illustrated by FIGS. 2A and 2B, Node 1 is the start node, and Node 9 is the end node. In other embodiments, the shortest path may be bidirectional. The graphs 200A and 200B can be encoded in spiking neuromorphic hardware, such as the neuromorphic processing unit 140 in FIG. 1. For instance, every node may be mapped to one or more neurons of the neuromorphic processing unit 140 and every edge between two nodes can be mapped to one or more synapses of the neuromorphic processing unit 140. The shortest path may be found by microcode updates to the variables of each vertex in response to wavefront of messages going forward from the start vertex to the end vertex.

The graph 200A is an example of unweighted graph. For the graph 200A, the shorted path would be the path has the least edges from the start node to the end node. In contrast, the graph 200B is an example of weighted graph. In many applications, graph edges may have associated numerical values, called weights. For illustration, the graph 200A in FIG. 2A has unweighted edges but the graph 200B in FIG. 2B has weighted edges. The numerical values on the edges of the graph 200B are example weights. For instance, the weight of the edge between Node 1 and Node 2 is +3, the weight of the edge between Node 2 and Node 4 is also +3, the weight of the edge between Node 4 and Node 6 is +1, and so on. Even though the weights in FIG. 2B are positive values, an edge weight may have a negative value. The edges can have weights that are either purely positive, both positive and negative, or purely negative. Also, the edges may have one or more weights that are not integers. Weighted graphs may be either directed or undirected. For illustration, the graph 200B in FIG. 2B is a directed weight graph. The direction is indicated by the arrows that are labeled with the weight values. In some embodiments, the weight of an edge may indicate a cost of the edge. The weight may be a measure or estimate of the length of a route, the capacity of a line, the energy required to move between locations along a route, and so on. For weighted graphs like the graph 200B, the shorted path may be a path with the least total weight from the start node to the end node. The total weight of a path may be the sum of the weights of its edges.

In some embodiments, the method in this disclosure can solve shortest path search in weighted graphs, using a specific mapping of the Bellman-Ford algorithm to neuromorphic hardware, together with a method for efficient read out of the solution. The graph 200B may be first encoded in a spiking neuromorphic hardware (e.g., the neuromorphic processing unit 140 in FIG. 1) as a network of microcoded neurons interconnected as per the input graph's topology. The graph 200B may be mapped to a neural network that is implemented on the spiking neuromorphic hardware. For instance, every vertex in the graph 200B may be mapped to a neuron. Every edge between two vertices may be mapped to several synapses.

The first step in the solution method may be to flag the source and target neurons that encode the source and target vertices, respectively. Then, the shortest path may be found by microcode updates to the variables of each vertex in response to wavefront of messages going forward from the start vertex to the end vertex. In every algorithmic step, neurons may receive messages from their neighboring neurons that signal an updated guess for their distance from the source neuron. When this updated distance is smaller than any guess that the neuron received previously, it may store this new distance and send a message to its neighboring neurons. The spike may propagate through the neural network in a spike wave. After (e.g., once or in response to that) the target neuron knows its depth (minimum distance from the source neuron), it may trigger a backward wavefront. In the backward wavefront, the target neuron may send messages to its neighboring neurons that allow the neighboring neurons to identify whether they are on a shortest path. After (e.g., once or in response to that) the neighboring neurons identify that they are, these neurons may spike their identifiers (IDs) and continue the backwards spike wave to their neighbors. The backward messages may sequentially activate the collection or streaming out of the IDs of vertices belonging to a shortest path in the form of graded spikes, e.g., spikes communicating integer (non-binary) values, or an encoding of the ID as position in a binary array. The vertex IDs can be streamed to a host (e.g., embedded CPUs in the system-on-chip), forwarded to other neural networks in the neuromorphic architecture, or directly streamed to ports connecting to peripheral CPUs or other devices. Using non-binary spiking payloads and customized neuron update rules and neuronal connectivity, the solution of the shortest path problem can be read out as soon as the shortest path is found.

For many applications, graph search can be part of a larger system that needs its solution to execute a sequence of commands. The subsystems can be assorted processes (such as graph constructors, input from sensors (e.g., vision or audio sensors), databases, etc.) that can feed information into the graph or consume the result of the graph search. The approach in this disclosure can map graphs and find the shortest path with the sequence of vertices that constitute it on special hardware that can reduce power consumption of the process. It can also speed up or scale up the process. Accelerated, efficient, weighted shortest path graph search can be implemented on hardware, such as neuromorphic chips. Programable neuromorphic hardware allows the usage of different types of update equations in each vertex of the graph (i.e., neuron in the neural network) thus allowing to solve variants of the graph search problems. Auxiliary operations can be integrated into and performed along the graph search. Furthermore, the compute-memory architecture of the hardware has the advantage of minimal data transfer between compute and memory elements across compute cycles. Certain aspects with respect to shortest path search are described below in conjunction with FIGS. 3A-3C and 4A-4C. Certain aspects with respect to spiking neuromorphic hardware are described below in conjunction with FIG. 5.

FIGS. 3a-3c illustrate spike propagation in a spiking neural network 300 during a forward spiking phase, in accordance with various embodiments. The forward spike propagation may be used to find shortest path in the graph. The shortest path search may be based on a new variation of the Bellman-Ford algorithm. In the example illustrated by FIGS. 3A-3C, the graph 200B in FIG. 2B is mapped to a spiking neural network 300. Each vertex of the graph corresponds to a neuron, and each edge to by several synapses between neurons. In the illustrated example, the spiking neural network 300 includes 9neurons corresponding to the 9 vertices of the graph 200B, respectively. The 9 neurons are represented by circles labeled with 1 through 9 in FIGS. 3A-3C. The 9 neurons are referred to as Neuron 1 through Neuron 9. In the illustrated example, Neuron 1 encodes the start node, and Neuron 9 encodes the end node.

In some embodiments, the spiking neural network 300 may be implemented on a spiking neuromorphic processor. Each neuron may be a processing element within the processor and can perform computations, such as subtraction, accumulation, multiplication, and so on. The lines linking the neurons indicate communicative connections between the neurons. The neurons may communicate with each other asynchronously using spikes that can be graded (have a range of values) or binary. A neuron may send data to one or more other neurons that the neuron is communicatively connected with. In some embodiments, a neuron may receive data from another neuron and compute new data based on the received data. A neuron may send out data, such as data computed by the neuron, when it spikes. A neuron may store data that is received or generated by the neuron in a memory associated with the neuron. The data stored in the memory of a neuron may indicate the internal state of the neuron, which may change during the forward spiking propagation. In some embodiments, a group of neurons may share a single memory. The memory (or memories) and the neurons may be implemented on the same chip.

Spikes may propagate through various paths in the spiking neural network 300. In some embodiments, a spike of information may propagate through multiple paths in the neural network. The multiple paths may have different lengths. A spike propagation may be initiated at Neuron 1, proceeds to the neurons directly connected to Neuron 1, and further proceeds to other neurons directly connected to those neurons. The spike propagation may stop when Neuron 9 is reached. The information in the spike may include a value that can be changed by the neurons that receive the spike during the propagation.

The internal states of the 9 neurons may all be initially set to d_{g}=∞, where d_{g} denotes distance from goal. The forward spiking phase includes a plurality of iterations, during which internal states of the neurons may change. Each iteration may be a single time step. For illustration, FIG. 3A shows the first time step, t=1; FIG. 3B shows the second time step, t=2; and FIG. 3C shows the fourth time step, t=4.

Before the first time step, the internal state of Neuron 1 is updated to d_{g}=0. For instance, Neuron 1 may receive a message indicating a payload value of 0. The message may indicate that Neuron 1 is the source neuron. Neuron 1 may compare the value of its initial state with the value in the message. After (e.g., in response to) determining that the value in the message is smaller, Neuron 1 may change its state to d_{g}=0 from d_{g}=∞. Neuron 1 also sends a spiking message to it neighboring neurons, i.e., Neuron 2 and Neuron 3. Neuron 2 and Neuron 3 may be referred to as the postsynaptic neurons. In some embodiments, Neuron 1 may send two messages to each postsynaptic neuron through the edges connecting Neuron 1 to the postsynaptic neuron. The weight of the edge connecting Neuron 1 and Neuron 2 is +3. The weight of the edge connecting Neuron 1 and Neuron 3 is +1. The first message may carry payload +1 and may be sent through a synapse of the edge weight, resulting in a payload of 1×w arriving at the postsynaptic neuron, where w is the edged weight. The second message may carry a payload d_{g}=0 through a synapse of weight +1, resulting in a payload of 1×d_{g}.

The two synapses received by each postsynaptic neuron may converge on the compute element DA of the postsynaptic neuron, which can provide hardware acceleration to add all incoming elements up, producing the incoming message. The DA may compute a sum of the values in the two synapses, i.e., 1×w+1×d_{g}=w+d_{g}. The incoming message received by Neuron 2 carries a value of 3, and the incoming message of Neuron 3 carries a value of 1. Neuron 2 and Neuron 3 can update their internal states based on the incoming messages during the first time step.

During the first time step (t=1), Neuron 2 and Neuron 3 may each perform a sequence of processing steps. Neuron 2 may determine whether its incoming message is smaller than its current internal state. In the illustrated example, the value carried by the incoming message is 3, and the current internal state of Neuron 2 is ∞, so the value of the incoming message is smaller. Neuron 2 then updates its internal state to the value of the incoming message so the new state of Neuron 2 becomes d_{g}=3, as shown in FIG. 3A. Neuron 2 also notifies its neighboring neuron (i.e., Neuron 4) that when shortest path goes via Neuron 2, its distance is 3. To convey this information, Neuron 2 sends two messages to Neuron 4 through the edge connecting them. The weight of the edge is +3. Neuron 4 is the postsynaptic neuron of Neuron 2 for the first time step. The two messages include a message that has payload +1 sent via a synapse of edge weight equal to 3, thus a payload of 1×3=3, and another message that has payload d_{g}=3 (i.e., the updated state of Neuron 2) via a synapse of weight +1, resulting in a payload of 1×3=3.

Similar to Neuron 2, Neuron 3 may determine whether its incoming message is smaller than its current internal state. In the illustrated example, the value carried by the incoming message is 1, and the current internal state of Neuron 3 is ∞, so the value of the incoming message is smaller. Neuron 3 then updates its internal state to the value of the incoming message so the new state of Neuron 3 becomes d_{g}=1, as shown in FIG. 3A. The internal state of Neuron 3 may be stored in a memory, and Neuron 3 may update its internal state by updating the memory. Neuron 3 also notifies its neighboring neuron (i.e., Neuron 4 and Neuron 5) that when shortest path goes via Neuron 3, its distance is 1. Even though Neuron 1 also neighbor Neuron 3, Neuron 1 may not receive messages from Neuron 3 or even if Neuron 1 receives messages from Neuron 3, Neuron 1 would take no action as the spiking propagation is forward. Neuron 4 and Neuron 5 are the postsynaptic neurons of Neuron 3 for the first time step. To convey the distance information, Neuron 3 sends two messages to each postsynaptic neuron through the corresponding edge. Neuron 4 receives two messages from Neuron 3: a message that has payload +1 sent via a synapse of edge weight equal to 2, thus a payload of 1×2=2, and another message that has payload d_{g}=1 (i.e., the updated state of Neuron 3) via a synapse of weight +1, resulting in a payload of 1×1=1. Neuron 5 receives two messages from Neuron 3: a message that has payload +1 sent via a synapse of edge weight equal to 5, thus a payload of 1×5=5, and another message that has payload d_{g}=1 (i.e., the updated state of Neuron 3) via a synapse of weight +1, resulting in a payload of 1×1=1. Other than Neuron 2 and Neuron 3, the other 7 neurons do not perform any memory update or send any messages out, leveraging the asynchronous nature of neuromorphic hardware.

During the second time step (t=2), Neuron 4 and Neuron 5 may each perform a sequence of processing steps. Neuron 4 may determine whether its incoming message is smaller than its current internal state. As described above, Neuron 4 receives messages from both Neuron 2 and Neuron 3. The DA of Neuron 4 may compute the incoming message from Neuron 2, which equals 3+3=6. The DA of Neuron 4 may also compute the incoming message from Neuron 3, which equals 2+1=3. Neuron 4 then updates its internal state to the smallest value of the incoming messages as the value is smaller than the current state of Neuron 4, which is ∞, so the new state of Neuron 4 becomes d_{g}=3, as shown in FIG. 3B. Neuron 4 also notifies its neighboring neuron (i.e., Neuron 6) that when shortest path goes via Neuron 4, its distance is 3. To convey this information, Neuron 4 sends two messages to Neuron 6 through the edge connecting them. The weight of the edge is +1. Neuron 6 is the postsynaptic neuron of Neuron 4 for the second time step. The two messages include a message that has payload +1 sent via a synapse of edge weight equal to 1, thus a payload of 1×1=1, and another message that has payload d_{g}=3 (i.e., the updated state of Neuron 4) via a synapse of weight +1, resulting in a payload of 1×3=3. Even though Neuron 2, Neuron 3, and Neuron 5 neighbor Neuron 4, they are not postsynaptic neurons of Neuron 4 for the forward spiking propagation.

Similar to Neuron 4, Neuron 5 may determine whether its incoming message is smaller than its current internal state. The value carried by the incoming message is 5+1=6, and the current internal state of Neuron 5 is ∞, so the value of the incoming message is smaller. Neuron 5 then updates its internal state to the value of the incoming message so the new state of Neuron 5 becomes d_{g}=6, as shown in FIG. 3B. Neuron 5 also notifies its neighboring neuron (i.e., Neuron 4 and Neuron 7) that when shortest path goes via Neuron 5, its distance is 6. Neuron 4 and Neuron 7 are the postsynaptic neurons of Neuron 5 for the second time step. To convey the distance information, Neuron 5 sends two messages to each postsynaptic neuron through the corresponding edge. Neuron 4 receives two messages from Neuron 5: a message that has payload +1 sent via a synapse of edge weight equal to 1, thus a payload of 1×1=1, and another message that has payload d_{g}=6 (i.e., the updated state of Neuron 5) via a synapse of weight +1, resulting in a payload of 1×6=6. Neuron 7 receives two messages from Neuron 5: a message that has payload +1 sent via a synapse of edge weight equal to 9, thus a payload of 1×9=9, and another message that has payload d_{g}=6 (i.e., the updated state of Neuron 5) via a synapse of weight +1, resulting in a payload of 1×6=6. Other than Neuron 4 and Neuron 5, the other 7 neurons do not perform any memory update or send any messages out, leveraging the asynchronous nature of neuromorphic hardware.

For illustration, the third time step (t=3) is not shown in FIGS. 3A-3C. In the third time step, Neuron 6 can update its internal state to d_{g}=4 based on the messages from Neuron 4. Neuron 7 can update its internal state to d_{g}=9+6=15 based on the messages from Neuron 5. Neuron 4 may not update its state based on the messages from Neuron 5, as the DA of Neuron 4 may compute that the incoming message from Neuron 5 has a value 1+6=7, which is higher than the current state of Neuron 4, i.e., d_{g}=3.

FIG. 3C shows the fourth time step (t=4), which may be the last time step of the forward spiking phase. During the last time step, the target neuron (i.e., Neuron 9) has received messages from Neuron 6, including a message that has payload +1 sent via a synapse of edge weight equal to 2, thus a payload of 1×2=2, and another message that has payload d_{g}=4 (i.e., the state of Neuron 6 updated in the third time step) via a synapse of weight +1, resulting in a payload of 1×4=4. The DA of Neuron 9 may compute 2+4=6. Neuron 9 may update its current state from D=∞to D=6, which is the length of the shortest path.

In the embodiments of FIGS. 3A-3C, the excitatory spike emanates from the start node and travels through the graph. Each neuron in the graph has a variable, dg, associated with it that keeps track of its minimum distance from the start node. This is done by constantly checking when the value of incoming spike is lower than the currently value of d_{g}(ho p_{fwd}). The neurons in the forward spike propagation may spike when the value of their d_{g} is updated. After (e.g., once) all neurons have spiked forward, the value of the shortest path can be globally broadcast to set state variable, D, for all neurons in the graph. Neurons that have received a spike are represented by dashed circles in FIGS. 3A-3C.

In some embodiments, all the 9 neurons may be connected to a supervisory unit. The supervisory unit may be a neuron or embedded CPU. In some embodiments, the supervisor unit is at least part of a host device. The 9 neurons may signal a message of +1 to the supervisory unit whenever they have updated their distance dᵢ. When the supervisory unit does not receive a single message in a time step, it can stop the execution since no shorter messages can be retrieved. In the illustrated example, the edges all have positive weights. The supervisory unit may receive an update from the target neuron t on its current guess for its distance, dₜ(D). It may also receive messages from neighboring neurons j whenever they have updated their guess dⱼ for their distance. The guesses dⱼ may arrive at a DM or at a range of DAs to extract the smallest value at each time step separately. When at any time step the smallest value of all new dⱼ is larger or equal to the dₜ, the shortest path search can be stopped early because all newly discovered paths from the source to the target neuron would have a path length longer than dₜ.

In some embodiments, a graph may have one or more edges with negative weight(s). The spiking neural network encoding the graph may run for a further time step, e.g., a total of |V| time steps, where |V| is the number of vertices of the graph. In embodiments where the target node receives a better distance in this time step, it may send a flag to the host CPU, signaling that at least one negative cycle exists. The reason is that any shortest path in a graph with |V| nodes can at most cover |V|−1 nodes. In embodiments where a shorter path is discovered after |V| time steps, there may be at least one negative cycle.

As a result of the forward spiking phase, all (relevant) neurons can know their shortest distance from the source node. After (e.g., once) the forward spiking phase completes, an efficient readout of the shortest path may be performed. The goal may be that each neuron that is on a shortest path sends its ID from the neuron core to a host for further use by the user. First, the target neuron may send its ID, then all nodes that are one edge closer to the source neuron on the shortest path, then all neurons that are two edges closer to the source neuron on the shortest path, and so on. In the example of FIGS. 3A-3C, Neuron 9 may first send its ID to the host, followed by Neuron 6 which is one edge closer to Neuron 1 on the shortest path, then Neuron 4 which is two edges closer to Neuron 1 on the shortest path, further Neuron 3 which is three edges closer to Neuron 1 on the shortest path, and finally Neuron 1 (i.e., the source neuron).

After the forward spike phase, a backward spike phase may be performed. The backward spike phase may involve a second set of synapses within the spiking neural network 300. The second set of synapses may be equivalent to the set of synapses for the forward spike phase, except that the direction is reversed.

FIGS. 4A-4C illustrate spike propagation in the spiking neural network 300 during a backward spiking phase, in accordance with various embodiments. The backward spike propagation may start after the forward spike propagation in FIGS. 3A-3C is completed. The backward spike propagation is in the opposite direction from the forward spike propagation. The backward spike propagation starts at the Neuron 9 and ends at the Neuron 1 through various paths between these two neurons. This pass may be conducted to readout all the neurons lying on the shortest path.

Neurons may have two state variables during the backward spiking phase: d_{g}(ho p_{bwd}) and dₛ(ho p_{fwd}), where dₛ denotes distance from source. The neurons may use state variables (e.g., ho p_{bwd}, D, ho p_{fwd}) to check whether a neuron that has received a spike is a solution for the shortest path. This is initiated by the target neuron (i.e., Neuron 9) sending its ho p_{bwd} as value of the spike. When a neuron receives a backward spike, it may assign the value of ho p_{bwd} as the sum of the edge weight and the incoming spike (ho p_{bwd} of successor neuron in shortest path). This value may be added to the ho p_{fwd} variable to check whether the sum is equal to the global depth. When the neuron is ascertained to be part of the solution, it can be read out.

The initial value of dₛ may be set to ∞ for all neurons. In some embodiments, the backward spiking phase is initiated once Neuron 9 has received its first spike, upon which a readout can be triggered. At this point, the neurons may start operating in backward mode. The backward spiking phase may include a sequence of time steps. Before the first time step (t=1), the internal state of Neuron 9 may be updated to dₛ=0, which may be done by sending a message carrying value 0 to Neuron 9. Neuron 9 may determine that 0 is smaller than ∞ and update its state accordingly. Neuron 9 may also initiate a spike wave that travels along the same connectivity in the opposite direction. For instance, Neuron 9 may send a spike to Neuron 6.

Neuron 6 receives the spike from Neuron 9 in the first time step, t=1. Neuron 6 may compare t with dₛ and determine that t is smaller. In response to determining that t is smaller, Neuron 6 may then update dₛ to the value of t, i.e., 1. Neuron 6 may also determine whether the sum of dₛ and d_{g} equals D. In response to determining that dₛ+d_{g}=D, Neuron 6 may send its ID to the host.

Neuron 4 may receive a spike from Neuron 6 in the second time step. Neuron 4 updates its dₛ to 2. For illustration, the second time step is not shown in FIGS. 4A-4C. FIG. 4B shows the third time step, t=3, during which Neuron 2, Neuron 3, Neuron 5, and Neuron 6 each receive a spike from Neuron 4. Neuron 5 may determine that dₛ+d_{g}>D, so it is not on the shortest path. Neuron 5 may not send out any spike or its ID. Neuron 6 may determine that t>dₛ, so Neuron 6 may not update its dₛ. Neuron 2 and Neuron 3 may both determine that dₛ+d_{g}=D, so they are on the shortest path. Neuron 2 and Neuron 3 may send their IDs to the host.

FIG. 4C shows the fourth time step, t=3, during which Neuron 1 receives a backward spike from Neuron 2 and Neuron 3. As the source neuron is reached, the backward spiking phase may end. In response to receiving the backward spike, Neuron 1 may send a flag to all the neurons to reset d_{g}, dₛ, and D of all neurons back to ∞. The spiking neural network 300 can be ready for the next shortest path search.

FIG. 5 illustrates an example spiking neuromorphic processor 500, in accordance with various embodiments. The spiking neuromorphic processor 500 may be an embodiment of the neuromorphic processing unit 140 in FIG. 1. The spiking neuromorphic processor 500 includes compute units 510 (individually referred to as “compute unit 510”), compute units 520 (individually referred to as “compute unit 520”), parallel input/output (IO) interfaces 530 (individually referred to as “parallel IO interface 530”), and a tour pin input/output (FPIO) interface 540. In other embodiments, alternative configurations, different or additional components may be included in the spiking neuromorphic processor 500. For example, the spiking neuromorphic processor 500 may include a different number of compute unit, parallel IO interface, or FPIO interface. As another example, the layout of the compute units 510 and 520 may be different. Further, functionality attributed to a component of the spiking neuromorphic processor 500 may be accomplished by a different component included in the spiking neuromorphic processor 500 or by a compute block.

The compute units 510 can train or deploy spiking neural networks, such as a neural network encoding a graph. A compute unit 510 may be referred to as a neural core. A neural core may include a plurality of neurons that may be integrated together. A neuron may be a compute element that can perform computations. For the purpose of illustration, a compute unit 510 includes nine neurons in FIG. 5. In other embodiments, a compute unit 510 may include a different number of neurons. For instance, the number of neurons in a compute unit 510 may be in a range from 100 to 1000. A compute unit 510 may be associated with a limited internal memory that can be accessed by the neurons during execution.

The neurons can communicate with each other asynchronously using binary (single-bit) or graded (multiple-bit) spikes or messages. In some embodiments, some or all the compute units 510 may be devoid of a clock. The notion of a time step may be maintained by a synchronization process that is a handshaking mechanism between the compute units 510 that is run when the spikes generated for each compute unit 510 are sent out. This can flush out all the remaining spiking activity and prepares the compute units 510 for the next algorithmic time step. Message passing can be done by using physical interconnects between the compute unit 510 or between neurons. The physical interconnects are represented by the dark lines and black circles in FIG. 5.

A compute unit 520 may be a CPU or part of a CPU (e.g., compact von Neumann CPUs). The compute units 520 may execute special functions not tenable on the computing units 510, e.g., some or all functions of the graph search module 105. In some embodiments, the compute units 520 are implemented on the same chip(s) as the compute units 510. In other embodiments, the compute units 520 are implemented on separate chips from the compute units 510. In some embodiments, one or more compute units 520 may be a host for shortest path search. The host may receive IDs of neurons on a shortest path within a graph.

The chip(s) can be scaled to increase the number of compute units 510 or 520, e.g., to accommodate large graphs. The chip-to-chip communication may be facilitated using the parallel IO interfaces 530 or the FPIO interface 540. The parallel IO interfaces 530 or the FPIO interface 540 can also offer support for Ethernet-based communication or other types of communications, such as slow serial communication.

The fine-grained parallelism, because of the distributed architecture, allows the approach in this disclosure to scale to graph search problems with millions of vertices while maintaining time to solution almost constant. This contrasts with von Neumann architectures where the time to solution could increase exponentially with increase in size when not parallelized (CPUs) or cut parallelization gains when too many parallel threads are in operation because of context switching (GPUs). Further, sparse communication coupled with the asynchronous nature of updates allows the approach in this disclosure to operate at orders of magnitude lower power than conventional von Neumann compute. Also, the in-memory compute allows to set and read the flags of neurons without von Neumann bottleneck.

In some embodiments, the host (e.g., host CPU) may receive the neurons of the shortest path in its reverse order, i.e., starting from the target vertex ending with the source vertex. In other embodiments, the algorithm can reverse the starting and target vertex. The host may receive the vertices of the shortest path in correct order, starting with the source vertex and ending with the target vertex. This can ensure that the application can already start using the shortest path even before the backwards path has fully uncovered it. For example, a robot moving from start to target location could already start moving, even though the readout has uncovered a part of the shortest path, as opposed to the whole path.

Spiking neuromorphic processors can support fine-grained parallelism that is adaptable to the parallelism of graph problems. This can enable the solution to a graph problem (e.g., the shortest path) to be found quickly. Also, the graph search module can ensure efficient readout of the sequence of nodes that constitute the solution. The complexity of the neuromorphic solution may scale with the actual length of the shortest path. A sequential algorithm on a separate processing unit (e.g., CPU) may scale with the number of edges. Also, the spiking neuromorphic processor can be aware of sparsity in data and operate or communicate on a need-to-use basis. For instance, the compute elements in spiking neuromorphic processor can operate or communicate asynchronously. Thus, the energy consumption for solving graph problems and for solution readout can be minimized.

The spiking neuromorphic processor can also scale well for graphs with a large number of nodes (e.g., up to millions, hundreds of millions, etc. nodes). The programmability of the spiking neuromorphic processor can allow it to be used for various types of graphs, including dynamically changing graphs, constrained graphs, graphs with constraints on the weights/nodes of the shortest path, and so on. Compared with the currently available techniques, the present disclosure provides a faster and more energy efficient approach to find shortest paths in graphs and to read out nodes that constitute shortest paths. The graph search system in the present disclosure can be used in mobile applications or applications that are limited by power or computation capacity.

The approach in this disclosure can speed up solving the shortest path algorithm and reading out the solution thereafter. Moreover, it can solve variants of the shortest path algorithm, e.g., shortest path algorithms with constraints. Any application that requires solving the shortest path algorithm can benefit from this approach.

Graph search algorithms can be an important part of robotics application. For example, it can be used to plan the shortest path subject from point A to point B with some constraints on the vertices in the graph. This would enable real-time operation of applications which require problems containing more than 10,000s of vertices. This is typically the case in, for example, wheeled robots used in warehouses and robotic arms. In the case of self-driving cars, this can go up to millions of vertices. The approach in this disclosure can quickly handle even this case in real time while consuming orders of magnitude lower power than conventional architectures.

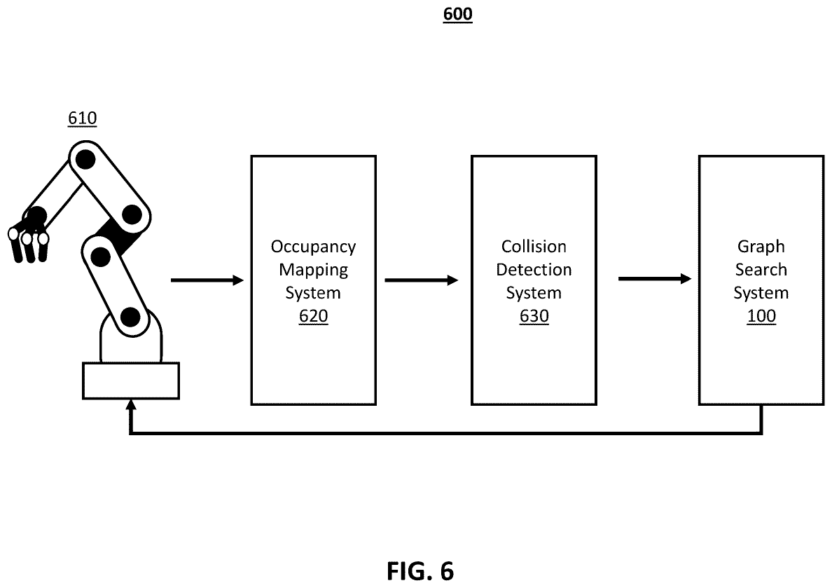

FIG. 6 illustrates an example process 600 of planning motion of a robot 601 using the graph search system 100 in FIG. 1, in accordance with various embodiments. For the purpose of illustration, the robot 601 has a movable arm. In other embodiments, the robot 601 may be different. For instance, the robot 601 may be an autonomous vehicle, a robot with different movable components, and so on.

The robot 610 may send a request to an occupancy mapping system 620 for mapping the occupancy of an environment where the robot 601 operates. In some embodiments, the robot 610 may provide sensor data captured by one or more sensors of the robot 610 to the occupancy mapping system 620. The sensor data may include images, point cloud, and so on.

The occupancy mapping system 620 may generate an occupancy model, such as an occupancy grid, etc. The occupancy model may include information indicating presence of one or more objects in the environment that may be obstacles of the robot 610 moving in the environment. In an embodiment, the occupancy mapping system 620 may generate an occupancy model including occupancy representations. An occupancy representation may be a representation of an object or one or more portions of an object or a representation of the space occupied by an object or one or more portions of an object. The occupancy mapping system 620 may generate occupancy representations by using geometric algorithms. The occupancy mapping system 620 may send the occupancy model to a collision detection system 630.

The collision detection system 630 may detect potential collisions of the robot 610 in the environment. For instance, the collision detection system 630 may detect obstacles in the environment for the robot 610 based on the occupancy model from the occupancy mapping system 620. For instance, the collision detection system 630 may determine whether an object is, could be, or would be an obstacle of the robot 610 based on the occupancy representation of the object. In some embodiments, the object is an obstacle of the robot 610 in scenarios where the object has collided, is colliding, or would collide with the robot 610 or the object can interfere with a movement of the robot 610, for instance, the object blocks a route along which the robot 610 travels. The collision detection system 630 may send information of the detected obstacles to the graph search system 100. The information may include locations of the detected obstacles, sizes of the detected obstacles, shapes of the detected obstacles, and so on.

The graph search system 100 may define a graph problem based on the information of the detected obstacles from the collision detection system 630. For instance, the graph search system 100 may generate a graph that represents at least part of the environment. A node in the graph may be a location in the environment. The location may be a destination of the robot 610, e.g., a location where the robot 610 is required to visit for completing a task. An edge between two nodes may represent a traveling path in the environment that has no detected obstacles. The graph search system 100 may define a start node representing a location where the movement of the robot 610 starts and a target node representing a destination where the movement of the robot 610 ends.

The graph search system 100 may use a neural network with a spike neuromorphic architecture to find the shortest path between the start location to the destination. In some embodiments, the graph search system 100 encodes the graph into a neural network including a plurality of neurons, each of which may encode a respective node in the graph. The neurons may be communicatively connected, and the communicative connection may represent the edges between the nodes encoded by the neurons.

The graph search system 100 can cause a forward spike propagation (an example of which is the forward spike propagation in FIGS. 3A-3C) and a backward spike propagation (an example of which is the backward spike propagation in FIGS. 4A-4C) in the neural network. Based on the two spike propagations, the graph search system 100 may identify neurons that encode the nodes on the shortest path. Further, the graph search system 100 can identify the nodes and determine the shortest path based on the identified nodes. The shortest path includes the start node, target node, identified node, and the edges between these nodes. The graph search system 100 may send the shortest path to the robot 610. The robot 610 may plan its motion based on the shortest path so that the robot 610 may reach the destination form the start location by taking the shortest path.

Even though FIG. 6 describes motion planning for the robot 610, the graph search system 100 may be used in other applications. For instance, the graph search system 100 may be used for e-marketing applications, such as routing and scheduling problems, arbitrage problems, and so on. The shortest path problem can be the backbone of routing and scheduling applications, such as routing in networks to minimize the number of hops between routers from source to destination, scheduling trains or flights, and so on.

Arbitrage is the act of buying or selling things across different markets, or in different forms, to profit from differences in prices. Arbitrage may involve making trade at very high speeds to exploit windows of opportunity. The arbitrage problem can be represented as graphs and decision to be taken as the nodes constituting the shortest path. Records of financial transactions may be stored as graphs. Implementation of shortest path search algorithms can be used to recognize and flag fraudulent transactions when used in conjunction with other machine-learning based classifiers. In an ecosystem of buyers and sellers interacting with one another, the trust between different members can be modelled as a function of the depth of the graph (e.g., value of the shortest path) of transactions connecting the different members.

Shortest path problems can also be the backbone of routing and scheduling applications. Select examples include: finding the route on a map as performed by Google Maps; routing in networks to minimize the number of hops between routers from source to destination; scheduling trains and flights, and so on. Spiking neuromorphic hardware can be scalable and therefore can be deployed in server-type form factors. A system can implement more than 1B neurons and thus solve theoretically solve single-source-shortest-path search for graphs with around 1B vertices fast and with low power.

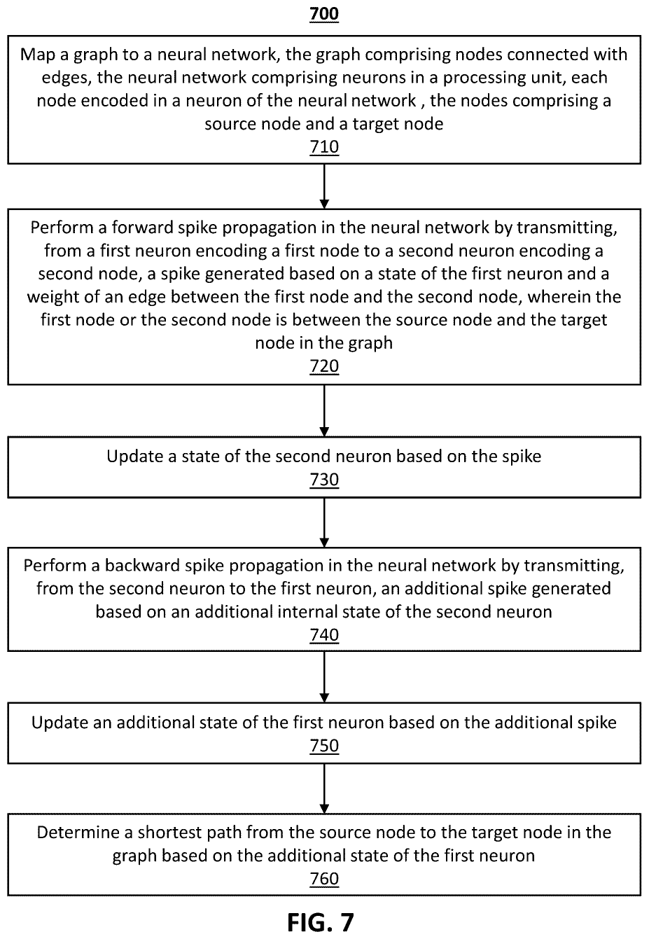

FIG. 7 is a flowchart showing a method 700 of graph path search, in accordance with various embodiments. The method 700 may be performed by the graph search system 100 in FIG. 1. Although the method 700 is described with reference to the flowchart illustrated in FIG. 7, many other methods for graph search may alternatively be used. For example, the order of execution of the steps in FIG. 7 may be changed. As another example, some of the steps may be changed, eliminated, or combined

The graph search system 100 maps 710 a graph to a neural network. The graph comprises nodes connected with edges. The neural network comprises neurons in a processing unit. Each node is encoded in a neuron of the neural network. The nodes include a source node and a target node.

The graph search system 100 performs 720 a forward spike propagation in the neural network by transmitting, from a first neuron encoding a first node to a second neuron encoding a second node, a spike generated based on a state of the first neuron and a weight of an edge between the first node and the second node. The first node or the second node is between the source node and the target node in the graph. In some embodiments, the spike comprises a first value and a second value. The first value corresponds to the state of the first neuron. The second value corresponds to the state of the weight of the edge. The first value and the second value are sent to the second neuron through two synapses.

The graph search system 100 updates 730 a state of the second neuron based on the spike. In some embodiments, the state of the first neuron indicates a distance between the first node and the target node in the graph. The state of the second neuron indicates a distance between the second node and the target node in the graph. In some embodiments, the second neuron comprises an accumulator. The graph search system 100 computes, by the accumulator, a sum of the first value and the second value. The graph search system 100 determines whether the sum is smaller than a current state value of the second neuron. In response to determining that the sum is smaller, the graph search system 100 modifies the current state value to the sum.

The graph search system 100 performs 740 a backward spike propagation in the neural network by transmitting, from the second neuron to the first neuron, an additional spike generated based on an additional internal state of the second neuron. In some embodiments, the backward spike propagation comprises a temporal sequence. The additional spike is transmitted during a time step in the temporal sequence. The time step has a positional index indicating a position of the time step in the temporal sequence.

The graph search system 100 updates 750 an additional state of the first neuron based on the additional spike. In some embodiments, the additional internal state of the second neuron indicates a distance between the second node and the source node in the graph, and the additional state of the first neuron indicates a distance between the first node and the source node in the graph. In some embodiments, the graph search system 100 determines whether the positional index of the time step is smaller than a value in the additional spike. In response to determining that the positional index of the time step is smaller than the value in the additional spike, the graph search system 100 modifies the value in the additional to the positional index of the time step in the sequence of time steps.

The graph search system 100 determines 760 a shortest path from the source node to the target node in the graph based on the additional state of the first neuron. In some embodiments, the graph search system 100 determines whether the first neuron is on the shortest path based on the state of the first neuron and the additional state of the first neuron. In response to determining that the first neuron is on the shortest path, the graph search system 100 provides, by the first neuron to an additional processing unit, an identifier of the first neuron. The graph search system 100 includes, by the additional processing unit, the first neuron into the shortest path based on the identifier of the first neuron.

In some embodiments, the graph search system 100 determines whether the first neuron is on the shortest path by computing a sum of the state of the first neuron and the additional state of the first neuron, determining whether the sum equals a distance between the source node and the target node, and in response to determining that the sum equals the distance, determining that the first neuron is on the shortest path. In some embodiments, the distance between the source node and the target node is determined based on the forward spike propagation. In some embodiments, the distance between the source node and the target node is a state of the target node.

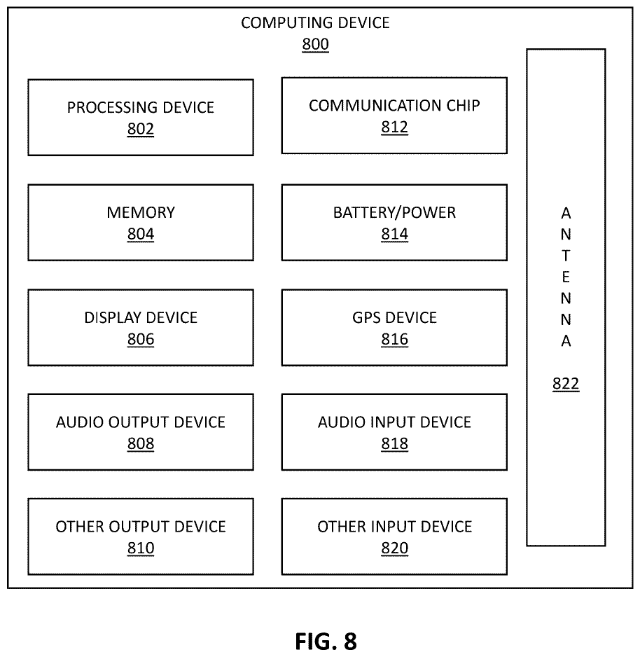

FIG. 8 is a block diagram of an example computing device 800, in accordance with various embodiments. In some embodiments, the computing device 800 may be used for at least part of the graph search system 100 in FIG. 1. A number of components are illustrated in FIG. 8 as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, but the computing device 800 may include interface circuitry for coupling to the one or more components. For example, the computing device 800 may not include a display device 806, but may include display device interface circuitry (e.g., a connector and driver circuitry) to which a display device 806 may be coupled. In another set of examples, the computing device 800 may not include an audio input device 818 or an audio output device 808, but may include audio input or output device interface circuitry (e.g., connectors and supporting circuitry) to which an audio input device 818 or audio output device 808 may be coupled.

The computing device 800 may include a processing device 802 (e.g., one or more processing devices). The processing device 802 processes electronic data from registers and/or memory to transform that electronic data into other electronic data that may be stored in registers and/or memory. The computing device 800 may include a memory 804, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 804 may include memory that shares a die with the processing device 802. In some embodiments, the memory 804 includes one or more non-transitory computer-readable media storing instructions executable for graph search, e.g., the method 700 described above in conjunction with FIG. 7 or some operations performed by the graph search system 100 in FIG. 1. The instructions stored in the one or more non-transitory computer-readable media may be executed by the processing device 802.

In some embodiments, the computing device 800 may include a communication chip 812 (e.g., one or more communication chips). For example, the communication chip 812 may be configured for managing wireless communications for the transfer of data to and from the computing device 800. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 812 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 812 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 812 may operate in accordance with other wireless protocols in other embodiments. The computing device 800 may include an antenna 822 to facilitate wireless communications and/or to receive other wireless communications (such as AM or FM radio transmissions).

In some embodiments, the communication chip 812 may manage wired communications, such as electrical, optical, or any other suitable communication protocols (e.g., the Ethernet). As noted above, the communication chip 812 may include multiple communication chips. For instance, a first communication chip 812 may be dedicated to shorter-range wireless communications such as Wi-Fi or Bluetooth, and a second communication chip 812 may be dedicated to longer-range wireless communications such as global positioning system (GPS), EDGE, GPRS, CDMA, WiMAX, LTE, EV-DO, or others. In some embodiments, a first communication chip 812 may be dedicated to wireless communications, and a second communication chip 812 may be dedicated to wired communications.

The computing device 800 may include battery/power circuitry 814. The battery/power circuitry 814 may include one or more energy storage devices (e.g., batteries or capacitors) and/or circuitry for coupling components of the computing device 800 to an energy source separate from the computing device 800 (e.g., AC line power).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include an audio output device 808 (or corresponding interface circuitry, as discussed above). The audio output device 808 may include any device that generates an audible indicator, such as speakers, headsets, or earbuds, for example.

The computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include another output device 810 (or corresponding interface circuitry, as discussed above). Examples of the other output device 810 may include an audio codec, a video codec, a printer, a wired or wireless transmitter for providing information to other devices, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smart phone, a mobile internet device, a music player, a tablet computer, a laptop computer, a netbook computer, an ultrabook computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 800 may be any other electronic device that processes data.

The following paragraphs provide various examples of the embodiments disclosed herein.

Example 1 provides one or more non-transitory computer-readable media storing instructions executable to perform operations, the operations including mapping a graph to a neural network, the graph including nodes connected with edges, the neural network including neurons in a processing unit, each node encoded in a neuron of the neural network, the nodes comprising a source node and a target node; performing a forward spike propagation in the neural network by transmitting, from a first neuron encoding a first node to a second neuron encoding a second node, a spike generated based on a state of the first neuron and a weight of an edge between the first node and the second node, in which the first node or the second node is between the source node and the target node in the graph; updating a state of the second neuron based on the spike; performing a backward spike propagation in the neural network by transmitting, from the second neuron to the first neuron, an additional spike generated based on an additional internal state of the second neuron; updating an additional state of the first neuron based on the additional spike; and determining a shortest path from the source node to the target node in the graph based on the additional state of the first neuron.

Example 2 provides the one or more non-transitory computer-readable media of example 1, in which the state of the first neuron indicates a distance between the first node and the target node in the graph, in which the state of the second neuron indicates a distance between the second node and the target node in the graph.

Example 3 provides the one or more non-transitory computer-readable media of example 1 or 2, in which the additional internal state of the second neuron indicates a distance between the second node and the source node in the graph, in which the additional state of the first neuron indicates a distance between the first node and the source node in the graph.

Example 4 provides the one or more non-transitory computer-readable media of any one of examples 1-3, in which the spike includes a first value and a second value, the first value corresponding to the state of the first neuron, the second value corresponding to the state of the weight of the edge, in which the first value and the second value are sent to the second neuron through two synapses.

Example 5 provides the one or more non-transitory computer-readable media of example 4, in which the second neuron includes an accumulator, in which updating the state of the second neuron includes computing, by the accumulator, a sum of the first value and the second value; determining whether the sum is smaller than a current state value of the second neuron; and in response to determining that the sum is smaller, modifying the current state value to the sum.

Example 6 provides the one or more non-transitory computer-readable media of any one of examples 1-5, in which the backward spike propagation includes a temporal sequence, in which the additional spike is transmitted during a time step in the temporal sequence, the time step having a positional index indicating a position of the time step in the temporal sequence, in which updating the additional state of the first neuron includes determining whether the positional index of the time step is smaller than a value in the additional spike; and in response to determining that the positional index of the time step is smaller than the value in the additional spike, modifying the value in the additional spike to the positional index of the time step.

Example 7 provides the one or more non-transitory computer-readable media of any one of examples 1-6, in which determining the shortest path includes determining whether the first neuron is on the shortest path based on the state of the first neuron and the additional state of the first neuron; in response to determining that the first neuron is on the shortest path, providing, by the first neuron to an additional processing unit, an identifier of the first neuron; and including, by the additional processing unit, the first neuron into the shortest path based on the identifier of the first neuron.

Example 8 provides the one or more non-transitory computer-readable media of example 7, in which determining whether the first neuron is on the shortest path includes computing a sum of the state of the first neuron and the additional state of the first neuron; determining whether the sum equals a distance between the source node and the target node; and in response to determining that the sum equals the distance, determining that the first neuron is on the shortest path.

Example 9 provides the one or more non-transitory computer-readable media of example 8, in which the distance between the source node and the target node is determined based on the forward spike propagation.

Example 10 provides the one or more non-transitory computer-readable media of example 8 or 9, in which the distance between the source node and the target node is a state of the target node.

Example 11 provides an apparatus, including a computer processor for executing computer program instructions; and a non-transitory computer-readable memory storing computer program instructions executable by the computer processor to perform operations, the operations including mapping a graph to a neural network, the graph including nodes connected with edges, the neural network including neurons in a processing unit, each node encoded in a neuron of the neural network, the nodes comprising a source node and a target node, performing a forward spike propagation in the neural network by transmitting, from a first neuron encoding a first node to a second neuron encoding a second node, a spike generated based on a state of the first neuron and a weight of an edge between the first node and the second node, wherein the first node or the second node is between the source node and the target node in the graph, updating a state of the second neuron based on the spike, performing a backward spike propagation in the neural network by transmitting, from the second neuron to the first neuron, an additional spike generated based on an additional internal state of the second neuron, updating an additional state of the first neuron based on the additional spike, and determining a shortest path from the source node to the target node in the graph based on the additional state of the first neuron.

Example 12 provides the apparatus of example 11, in which the state of the first neuron indicates a distance between the first node and the target node in the graph, in which the state of the second neuron indicates a distance between the second node and the target node in the graph.

Example 13 provides the apparatus of example 11 or 12, in which the additional internal state of the second neuron indicates a distance between the second node and the source node in the graph, in which the additional state of the first neuron indicates a distance between the first node and the source node in the graph.

Example 14 provides the apparatus of any one of examples 11-13, in which the spike includes a first value and a second value, the first value corresponding to the state of the first neuron, the second value corresponding to the state of the weight of the edge, in which the first value and the second value are sent to the second neuron through two synapses.

Example 15 provides the apparatus of example 14, in which the second neuron includes an accumulator, in which updating the state of the second neuron includes computing, by the accumulator, a sum of the first value and the second value; determining whether the sum is smaller than a current state value of the second neuron; and in response to determining that the sum is smaller, modifying the current state value to the sum.

Example 16 provides the apparatus of any one of examples 11-15, in which the backward spike propagation includes a temporal sequence, in which the additional spike is transmitted during a time step in the temporal sequence, the time step having a positional index indicating a position of the time step in the temporal sequence, in which updating the additional state of the first neuron includes determining whether the positional index of the time step is smaller than a value in the additional spike; and in response to determining that the positional index of the time step is smaller than the value in the additional spike, modifying the value in the additional spike to the positional index of the time step.

Example 17 provides the apparatus of any one of examples 11-16, in which determining the shortest path includes determining whether the first neuron is on the shortest path based on the state of the first neuron and the additional state of the first neuron; in response to determining that the first neuron is on the shortest path, providing, by the first neuron to an additional processing unit, an identifier of the first neuron; and including, by the additional processing unit, the first neuron into the shortest path based on the identifier of the first neuron.

Example 18 provides the apparatus of example 17, in which determining whether the first neuron is on the shortest path includes computing a sum of the state of the first neuron and the additional state of the first neuron; determining whether the sum equals a distance between the source node and the target node; and in response to determining that the sum equals the distance, determining that the first neuron is on the shortest path.

Example 19 provides the apparatus of example 18, in which the distance between the source node and the target node is determined based on the forward spike propagation.

Example 20 provides the apparatus of example 18 or 19, in which the distance between the source node and the target node is a state of the target node.

Example 21 provides a method, including mapping a graph to a neural network, the graph including nodes connected with edges, the neural network including neurons in a processing unit, each node encoded in a neuron of the neural network, the nodes comprising a source node and a target node; performing a forward spike propagation in the neural network by transmitting, from a first neuron encoding a first node to a second neuron encoding a second node, a spike generated based on a state of the first neuron and a weight of an edge between the first node and the second node, wherein the first node or the second node is between the source node and the target node in the graph; updating a state of the second neuron based on the spike; performing a backward spike propagation in the neural network by transmitting, from the second neuron to the first neuron, an additional spike generated based on an additional internal state of the second neuron; updating an additional state of the first neuron based on the additional spike; and determining a shortest path from the source node to the target node in the graph based on the additional state of the first neuron.

Example 22 provides the method of example 21, in which the state of the first neuron indicates a distance between the first node and the target node in the graph, in which the state of the second neuron indicates a distance between the second node and the target node in the graph, in which the additional internal state of the second neuron indicates a distance between the second node and the source node in the graph, in which the additional state of the first neuron indicates a distance between the first node and the source node in the graph.

Example 23 provides the method of example 21or 22, in which the spike includes a first value and a second value, the first value corresponding to the state of the first neuron, the second value corresponding to the state of the weight of the edge, in which the first value and the second value are sent to the second neuron through two synapses, in which updating the state of the second neuron includes computing, by an accumulator of the second neuron, a sum of the first value and the second value; determining whether the sum is smaller than a current state value of the second neuron; and in response to determining that the sum is smaller, modifying the current state value to the sum.

Example 24 provides the method of any one of examples 21-23, in which the backward spike propagation includes a temporal sequence, in which the additional spike is transmitted during a time step in the temporal sequence, the time step having a positional index indicating a position of the time step in the temporal sequence, in which updating the additional state of the first neuron includes determining whether the positional index of the time step is smaller than a value in the additional spike; and in response to determining that the positional index of the time step is smaller than the value in the additional spike, modifying the value in the additional spike to the positional index of the time step.

Example 25 provides the method of any one of examples 21-24, in which determining the shortest path includes determining whether the first neuron is on the shortest path based on the state of the first neuron and the additional state of the first neuron; in response to determining that the first neuron is on the shortest path, providing, by the first neuron to an additional processing unit, an identifier of the first neuron; and including, by the additional processing unit, the first neuron into the shortest path based on the identifier of the first neuron.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. One or more non-transitory computer-readable media storing instructions executable to perform operations, the operations comprising:
mapping a graph to a neural network, the graph comprising nodes connected with edges, the neural network comprising neurons in a processing unit, each node encoded in a neuron of the neural network, the nodes comprising a source node and a target node;
performing a forward spike propagation in the neural network by transmitting, from a first neuron encoding a first node to a second neuron encoding a second node, a spike generated based on a state of the first neuron and a weight of an edge between the first node and the second node, wherein the first node or the second node is between the source node and the target node in the graph;
updating a state of the second neuron based on the spike;
performing a backward spike propagation in the neural network by transmitting, from the second neuron to the first neuron, an additional spike generated based on an additional internal state of the second neuron;
updating an additional state of the first neuron based on the additional spike; and
determining a shortest path from the source node to the target node in the graph based on the additional state of the first neuron.

2. The one or more non-transitory computer-readable media of claim 1, wherein the state of the first neuron indicates a distance between the first node and the target node in the graph, wherein the state of the second neuron indicates a distance between the second node and the target node in the graph.

3. The one or more non-transitory computer-readable media of claim 1, wherein the additional internal state of the second neuron indicates a distance between the second node and the source node in the graph, wherein the additional state of the first neuron indicates a distance between the first node and the source node in the graph.

4. The one or more non-transitory computer-readable media of claim 1, wherein the spike comprises a first value and a second value, the first value corresponding to the state of the first neuron, the second value corresponding to the state of the weight of the edge, wherein the first value and the second value are sent to the second neuron through two synapses.

5. The one or more non-transitory computer-readable media of claim 4, wherein the second neuron comprises an accumulator, wherein updating the state of the second neuron comprises:
computing, by the accumulator, a sum of the first value and the second value;
determining whether the sum is smaller than a current state value of the second neuron; and
in response to determining that the sum is smaller, modifying the current state value to the sum.

6. The one or more non-transitory computer-readable media of claim 1, wherein the backward spike propagation comprises a temporal sequence, wherein the additional spike is transmitted during a time step in the temporal sequence, the time step having a positional index indicating a position of the time step in the temporal sequence, wherein updating the additional state of the first neuron comprises:
determining whether the positional index of the time step is smaller than a value in the additional spike; and
in response to determining that the positional index of the time step is smaller than the value in the additional spike, modifying the value in the additional spike to the positional index of the time step.

7. The one or more non-transitory computer-readable media of claim 1, wherein determining the shortest path comprises:
determining whether the first neuron is on the shortest path based on the state of the first neuron and the additional state of the first neuron;
in response to determining that the first neuron is on the shortest path, providing, by the first neuron to an additional processing unit, an identifier of the first neuron; and
including, by the additional processing unit, the first neuron into the shortest path based on the identifier of the first neuron.

8. The one or more non-transitory computer-readable media of claim 7, wherein determining whether the first neuron is on the shortest path comprises:
computing a sum of the state of the first neuron and the additional state of the first neuron;
determining whether the sum equals a distance between the source node and the target node; and
in response to determining that the sum equals the distance, determining that the first neuron is on the shortest path.

9. The one or more non-transitory computer-readable media of claim 8, wherein the distance between the source node and the target node is determined based on the forward spike propagation.

10. The one or more non-transitory computer-readable media of claim 8, wherein the distance between the source node and the target node is a state of the target node.

11. An apparatus, comprising:
a computer processor for executing computer program instructions; and
a non-transitory computer-readable memory storing computer program instructions executable by the computer processor to perform operations, the operations comprising:
mapping a graph to a neural network, the graph comprising nodes connected with edges, the neural network comprising neurons in a processing unit, each node encoded in a neuron of the neural network, the nodes comprising a source node and a target node,
performing a forward spike propagation in the neural network by transmitting, from a first neuron encoding a first node to a second neuron encoding a second node, a spike generated based on a state of the first neuron and a weight of an edge between the first node and the second node, wherein the first node or the second node is between the source node and the target node in the graph,
updating a state of the second neuron based on the spike,
performing a backward spike propagation in the neural network by transmitting, from the second neuron to the first neuron, an additional spike generated based on an additional internal state of the second neuron,
updating an additional state of the first neuron based on the additional spike,
and
determining a shortest path from the source node to the target node in the graph based on the additional state of the first neuron.

12. The apparatus of claim 11, wherein the state of the first neuron indicates a distance between the first node and the target node in the graph, wherein the state of the second neuron indicates a distance between the second node and the target node in the graph.

13. The apparatus of claim 11, wherein the additional internal state of the second neuron indicates a distance between the second node and the source node in the graph, wherein the additional state of the first neuron indicates a distance between the first node and the source node in the graph.

14. The apparatus of claim 11, wherein the spike comprises a first value and a second value, the first value corresponding to the state of the first neuron, the second value corresponding to the state of the weight of the edge, wherein the first value and the second value are sent to the second neuron through two synapses.

15. The apparatus of claim 14, wherein the second neuron comprises an accumulator, wherein updating the state of the second neuron comprises:
computing, by the accumulator, a sum of the first value and the second value;
determining whether the sum is smaller than a current state value of the second neuron; and
in response to determining that the sum is smaller, modifying the current state value to the sum.

16. The apparatus of claim 11, wherein the backward spike propagation comprises a temporal sequence, wherein the additional spike is transmitted during a time step in the temporal sequence, the time step having a positional index indicating a position of the time step in the temporal sequence, wherein updating the additional state of the first neuron comprises:
determining whether the positional index of the time step is smaller than a value in the additional spike; and
in response to determining that the positional index of the time step is smaller than the value in the additional spike, modifying the value in the additional spike to the positional index of the time step.

17. The apparatus of claim 11, wherein determining the shortest path comprises:
determining whether the first neuron is on the shortest path based on the state of the first neuron and the additional state of the first neuron;
in response to determining that the first neuron is on the shortest path, providing, by the first neuron to an additional processing unit, an identifier of the first neuron; and
including, by the additional processing unit, the first neuron into the shortest path based on the identifier of the first neuron.

18. A method, comprising:
mapping a graph to a neural network, the graph comprising nodes connected with edges, the neural network comprising neurons in a processing unit, each node encoded in a neuron of the neural network, the nodes comprising a source node and a target node;
performing a forward spike propagation in the neural network by transmitting, from a first neuron encoding a first node to a second neuron encoding a second node, a spike generated based on a state of the first neuron and a weight of an edge between the first node and the second node, wherein the first node or the second node is between the source node and the target node in the graph;
updating a state of the second neuron based on the spike;
performing a backward spike propagation in the neural network by transmitting, from the second neuron to the first neuron, an additional spike generated based on an additional internal state of the second neuron;
updating an additional state of the first neuron based on the additional spike; and
determining a shortest path from the source node to the target node in the graph based on the additional state of the first neuron.

19. The method of claim 18, wherein the state of the first neuron indicates a distance between the first node and the target node in the graph, wherein the state of the second neuron indicates a distance between the second node and the target node in the graph, wherein the additional internal state of the second neuron indicates a distance between the second node and the source node in the graph, wherein the additional state of the first neuron indicates a distance between the first node and the source node in the graph.

20. The method of claim 18, wherein the spike comprises a first value and a second value, the first value corresponding to the state of the first neuron, the second value corresponding to the state of the weight of the edge, wherein the first value and the second value are sent to the second neuron through two synapses, wherein updating the state of the second neuron comprises:
computing, by an accumulator of the second neuron, a sum of the first value and the second value;
determining whether the sum is smaller than a current state value of the second neuron; and
in response to determining that the sum is smaller, modifying the current state value to the sum.
